(19) United States
(12) Patent Application Publication
(10) Pub. No.: US 2004/0247003 A1
(43) Pub. Date: Dec. 9, 2004

(54) Laser apparatus

(76) Inventor: Ian Peter Mercer, Keymer (GB)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/484,048

(22) PCT Filed: Jul. 22, 2002
(86) PCT No.: PCT/GB02/03367

(30) Foreign Application Priority Data
Jul. 20, 2001 (GB) 0117788.0

(51) Int. Cl. H01S 3/04

(52) U.S. Cl. 372/35; 372/34

(57) ABSTRACT

A laser apparatus includes pumping means to emit pumping radiation, a gain medium to absorb the radiation and emit a laser light, and cooling means to cool the gain medium. The cooling means includes a coolant comprising of D₂O.

### BACKGROUND OF THE INVENTION

Field of the Invention—The present invention relates to a laser apparatus, and in particular, to an apparatus to cool an optically side-pumped solid state laser gain medium.

Conventional lasers include a gain medium, such a laser rod, and an optical pumping means, such as a stack of diodes. The diodes emit pumping radiation that is directed to the rod. A portion of the pumping radiation is absorbed, pumping ions in the rod from a ground to an excited state. During relaxation back to their ground state, the ions emit laser light by spontaneous emission.

A problem with all lasers, including solid state lasers, is that only a portion of the pumping radiation is converted into laser light. A proportion of the remaining radiation is transferred to deleterious mechanisms, such as heating of the gain medium. It is therefore necessary to counteract these thermal effects of the pumping radiation by cooling the gain medium.

Typical laser cooling systems employ fluid convection flow, with water as the coolant, as shown in FIG. 1. Compared to other coolants, water has the highest specific heat and thermal conductivity and the lowest viscosity. As such, water can remove the largest heat load from the gain medium.

However, such prior art devices suffer from several disadvantages. The radiation absorption levels of coolant water is strongly dependent upon the wavelength of the pumping radiation, especially in a range of interest for the pumping of high power solid state lasers between 800 and 1000 nm. For example, its decadic absorption coefficient increases from 0.01/cm at 800 nm to 0.08/cm at 940 nm (a suitable wavelength for the pumping of Yb:YAG) and peaking at 0.21/cm at 976 nm, as shown in FIG. 2.

For gain media requiring pumping radiation at wavelengths at which water has a significant absorption coefficient, such as ytterbium (Yb) doped media like Ytterbium doped Yttrium Aluminum Garnet (Yb:YAG) or Ytterbium doped Potassium Gadolinium Tungstate (Yb:KGW), a significant proportion of the pump radiation is absorbed by the coolant. This has two disadvantages: firstly, the efficiency of the pumping is reduced; and secondly the pumping radiation acts to heat the coolant itself, which translates to a higher temperature for the gain medium.

These disadvantages are manifested in pumping geometries where the pumping radiation has to pass through the coolant before reaching the gain medium—for example, where the gain medium is “side-pumped”. In such systems, the disadvantages of using water as a coolant can be compounded when gain media have either a small absorption cross section or the overlap in wavelengths between the pumping radiation and the absorption band is not complete, such that the pumping radiation typically has to pass many times through the gain medium (and therefore the coolant) before it is absorbed. An example of a gain medium with a small cross section of absorption is Yb:YAG, which has a cross section of absorption of ˜0.8×10⁻²⁰ cm² at its typical pumping wavelength of 940 nm, compared to that of Nd:YAG, at ˜6×10⁻²⁰ cm² (at 808 nm). In a side-pumping configuration suitable for efficient energy extraction from Yb:YAG, multiple passes of the pumping radiation are required. Even though water is not at its peak of absorption at 940 nm, when combined with the low absorption for a Yb:YAG gain medium, a typical embodiment would see half of the pump energy directly absorbed in to the water.

U.S. Pat. No. 5,471,491 discloses an impingement cooling system aimed at improving pumping efficiency. The apparatus includes a gain medium in the form of a centrally located laser rod surrounded by light transmitting jet sleeves. An inner jet sleeve directs coolant through jet holes to impinge upon the laser rod. The impingement cooling apparatus is complex, being difficult to manufacture and assemble, requiring multiple flow cavities and precise alignment.

U.S. Pat. No. 5,636,239 discloses an impingement cooling system for Yb-based gain media in which the coolant used is pressurized methyl alcohol (methanol, MeOH). As shown in FIG. 2, methanol has a lower absorption coefficient than water at wavelengths of 922 to 1000 nm, and has a minimum in absorption coefficient at ˜949 nm, making it a candidate for pumping of Yb:YAG, with an absorption coefficient of 0.026/cm at 940 nm. By using a combination of impingement cooling and methanol as a coolant, pumping and cooling efficiency is improved. However, the apparatus is still complex to manufacture and assemble, and the design is necessarily focused on incorporating impingement cooling, at a cost to the optimization of other design parameters.

A further reference, European Patent. Application EP0854551 relates to a slab geometry 3-level laser system. According to this arrangement a slab-type gain medium is side pumped by an excitation mechanism generating polarized light parallel with the principal absorption axis of the gain medium. A cooling system comprises a channel between the excitation mechanism and the gain medium through which D₂O passes. D₂O is selected as it transmits at the lasing wavelength. This is required for operation, as the slab relies on total internal reflection to guide laser light and D₂O hence provides the appropriate absorption property at the interface. In this system, a problem arises with spontaneous emission from the gain medium at the lasing wavelength, in the region of 2 μm to 3 μm. As light at this wavelength interacts with D₂O, unwanted absorption of the amplified laser beam by the cooling medium is reduced against prior systems. However this arrangement is restricted to systems using total internal reflection at long wavelengths in the Infra Red region.

Further problems exist with known side pumped systems. Because of the roughened surface, there is a decrease in efficiency at the ends where pump radiation exits the rod. Further problems exist with the configuration of reflectors in known side pumping arrangements. The reflector arrangements for directing escaping pump radiation back into the rod typically comprise either a dielectric coating or a metallic coating. Metallic coatings can degrade under irradiance from the full power of the diode pumping which is a significant problem where there is low absorption in the gain medium. Even though dielectric coatings are able to operate under those conditions without degradation, such coatings generally reflect without a narrower range of incident angles, in the range from 0° to 40° from normal being achievable.

### SUMMARY OF THE INVENTION

According to the present invention, there is provided a laser as set out in the claims.

The present invention offers the advantages of being of simple construction, yet functionally efficient. The apparatus does not require the use of a complex cooling system. The low absorption coefficient for pumping radiation, high specific heat, high thermal conductivity and low viscosity of D₂O means that it is simultaneously efficient at removal of heat, whilst absorbing an insignificant proportion of the pumping radiation. Indeed, D₂O maintains the cooling advantages of H₂O and is estimated to be able to remove up to 200 W/cm², but also has a very low absorption coefficient that results in an insignificant absorption of pumping radiation across the important region for the pumping of high power solid state laser media between approximately 800 and approximately 1300 nm, more preferably 900 nm to 1000 nm, most preferably about 950 nm. As a result, it is generally possible to use the same coolant and cooling method for application to a wide variety of high average power solid state laser media, and in a wide range of pumping configurations.

Preferably, the coolant is disposed between the pump source and the gain medium. The pumping means may have first and second ends on a laser extraction axis; and the pump source may be arranged so that the pumping radiation is directed to a side of the gain medium. The advantages of a side pumping scheme is that it is possible to maintain a low intensity of the pumping radiation, translating to a low thermal load on optical coatings and surfaces of the apparatus, which in turn leads to greater robustness with reduced chance of damage, and generally to reduced complexity in the production of diode pump units. Further, the side surfaces of the gain medium need not be polished. In other embodiments, other pump configurations are used.

Preferably, the gain medium includes a diffusely scattering surface. The diffusely scattering surface, which can be a diffusely reflecting surface, inhibits specular i.e., mirror-like reflection and refraction and introduces diffuse scattering. This can significantly improve overall performance of the laser system by reducing parasitic laser action as well as contributing to a more homogeneous distribution of pumping radiation.

The gain medium may have a diffusely scattering surface having specularly reflecting regions at each end. In one embodiment, the sides at the ends of the gain medium may be polished in order to enhance total internal reflection of pumping radiation back in to the gain medium. This can lead to improved efficiency of coupling pump radiation back in to the laser medium. The polished region will typically extend for a length equivalent to approximately one to two times the width of the medium.

The gain medium preferably has a length of absorption such that on average, the radiation performs multiple passes through the gain medium prior to absorption thereby, for example more than four passes. In another embodiment, the number of passes prior to absorption is typically ten.

The invention is thus of benefit where for a desired pumping wavelength, the cross section for absorption in standard cooling fluids such as water is high, such that in 1 to 20 passes, significant energy has been directly deposited into the coolant fluid. In another embodiment, the number of passes prior to absorption in the gain medium is typically 4, where there is an incomplete overlap of the pumping band of wavelengths and the desired band of absorption in the lasing medium, such that although the peak absorption cross section in the lasing medium may be high and the doping concentration of active ions may also be high, the overall absorption length for the pumping radiation in question may still be long, the invention is also advantageous. In this case, multiple passes may be required to absorb the pumping radiation, and the use of standard water or other standard coolants could result in a significant decrease in efficiency for the device. An example where standard pumping solutions are broader than the preferred absorption band for the lasing medium is for Yb:KGW which has a bandwidth of 3.7 nm in comparison to cost effective, standard diode units which have a bandwidth of 6 nm. A scheme employing more passes through the gain medium has the advantage that is it more robust to changes in bandwidth or center wavelength of the pumping source.

Preferably the gain medium is Yb based. Preferably, the medium is based on Yb doping, the most common form being Yb:YAG. Alternatively, other Yb doped host materials such as KGW (KGd(WO₄)₂), KYW (KY(WO₄)₂), GGG and sesquioxides (Sc₂O₃, Y₂O₃, Lu₂O₃) may also be used. Yb based materials can lend themselves to a side pumping scheme requiring multiple passes of the gain medium due to either their low cross section for pump absorption (for example with the effective cross section for Yb:YAG being ˜0.8×10⁻²⁰ cm²) or having absorption bandwidths narrower than that for the diode pumping units (for example the bandwidth of Yb:KGW is 3.7 nm in comparison to standard currently available diode pumping units of bandwidth 6 nm). These two factors can result in a long absorption length for a doping level that would facilitate efficient laser action.

Preferably, the gain medium is rod shaped. In other embodiments, the gain medium is of different shapes, for example, the gain medium is any elongate or slab-like shape.

The pumping means may comprise a laser diode. In an alternative embodiment, other optical pumping means are used, such as flash lamp pumping.

The cooling arrangement may comprise a convection cooling system. Other embodiments use other cooling systems, such as impingement cooling or conduction cooling from side surfaces.

The cooling can be applied around the elongated surfaces of the gain medium, to all sides (typical for the embodiment of a rod with fluid convection cooling), or to a restricted regions, for example in one embodiment to an interface with two sides of a slab-like elongated medium, and in another embodiment to one side of a slab-like elongated medium.

The gain medium may be surrounded by a first reflector layer comprising a dielectric reflecting layer and a second reflector layer comprising a metallic reflecting layer. The layers may be coated one on the other, or may be spaced from one another. As a result, the inner dielectric layer reflects the majority of pump radiation generally save that impinging at greater than 40°. The outer, metallic layer reflects the remainder of the radiation as it is direction independent. Because only a restricted amount of pump radiation reaches the metallic layer, however, there is reduced risk of degradation.

According to the invention there is further provided a laser apparatus comprising a pump radiation source to emit pumping radiation and a gain medium arranged to absorb the radiation and thereby emit laser light, in which the gain medium is surrounded by a first reflector layer comprising a dielectric reflecting layer and a second reflector layer comprising a metallic reflecting layer.

According to the invention there is still further provided a laser apparatus comprising a pump radiation source to emit pumping radiation and a gain medium arranged to absorb the radiation and thereby emit laser light, in which the gain medium has first and second ends on a laser extraction axis and a diffusely scattering surface between the ends, wherein the diffusely scattering surface has specularly reflecting regions at each end.

### DESCRIPTION OF THE DRAWINGS

The present invention can be put into practice in several ways. A specific embodiment will now be described, by way of example, with reference to the accompanying drawings, in which:

FIG. 1 is a schematic diagram of a cooling configuration for a side pumped laser;

FIG. 2 is a cross sectional view of the arrangement shown in FIG. 1; and

FIG. 3 is a graph showing the decadic absorption coefficients for water, methanol, and heavy water versus wavelength.

### DETAILED DESCRIPTION OF THE PREFERRED EMBODIMENT

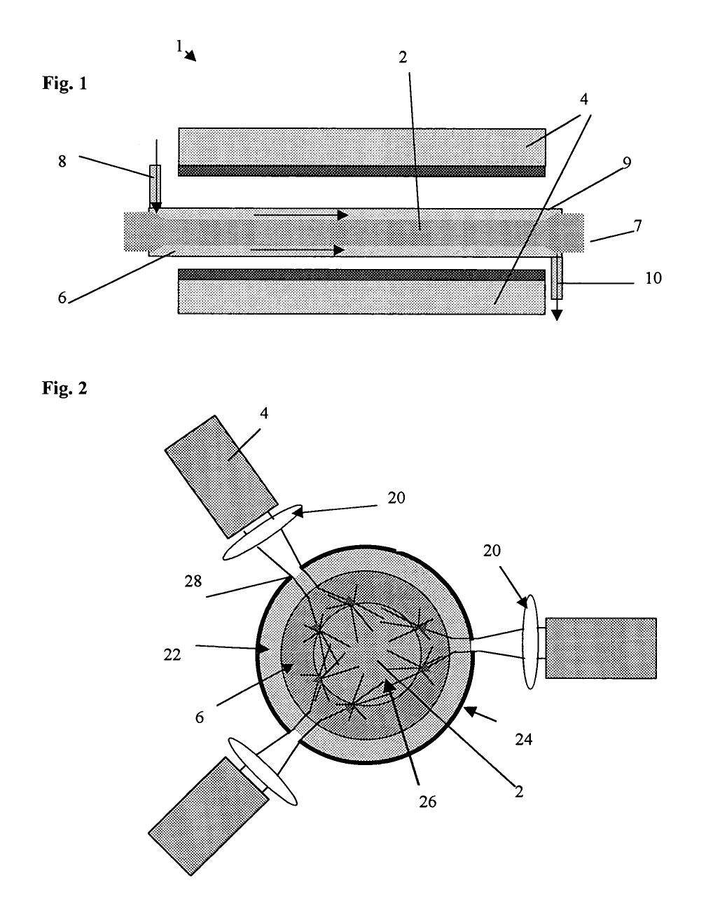

FIGS. 1 and 2 are schematic diagrams of a laser pump apparatus 1 of the present invention. The apparatus includes a laser gain medium of a general rod-shape, made of Yb:YAG.

Two diode bar sources 4 together with appropriate conditioning and forming optics of the type well known to the skilled person are positioned along the longitudinal sides of the rod 2. The sources 4 are made up of a stack of solid state diodes emitting at a suitable wavelength for absorption in the gain medium. For Yb:YAG, a typical diode material is that of InGaAs. The diode sources emit pumping radiation in the direction of longitudinal sides of the gain medium 2. The source can be of any appropriate type or will be well known to the skilled reader.

A convection fluid flow cooling system 6 is arranged to cool the gain medium 2. A coolant, heavy water (D₂O), is pumped through an inlet 8 into a longitudinal flow pumping system surrounding the gain medium 2, and flows out through an outlet 10 in a continuous convection cooling process. The preferred embodiment consists of a single inlet and outlet, however multiple inlets and outlets may be incorporated. In operation, radiation at a wavelength matched to the gain medium excitation wavelength, i.e. ˜941 nm for Yb:YAG, is emitted from the diode bar sources towards the rod 2. Typically, the radiation is predominantly reflected to-and-fro through the gain medium and coolant until it is absorbed by the gain medium.

In the embodiment the rod has width 2 to 4 mm, length 20 to 60 mm, active ion doping 0.5 to 3%, flow tube 9 inner width 2 to 8 mm greater than rod width, flow tube wall thickness 2 to 3 mm. Diode pumping power for a typical application is 100 W to 10 kW, however some embodiments are scalable in their application to higher powers.

Further details of the arrangement can be seen in FIG. 2. One possible configuration of reflective/refractive optics 20 is shown although such optics may not be required at all in some embodiments. The rod 2 is surrounded by coolant 6 which is confined by an outer wall of glass, sapphire or other optically transparent, resilient and hard material. The scattering mechanism is shown generally at 26, where the pump radiation predominantly reflects off the outer wall 9 of the flow tube to re-couple into the gain medium, forming a pump radiation reflective chamber.

The arrangement shown has 3-fold symmetry and typical arrangements for diode pumping have from 2 to 7 fold symmetry about the rod. The diode radiation couples through gaps 28 in the high reflector and in the case of multiple passing of the gain medium, the gaps 28 in the reflectors must be reduced to slits in order to minimize loss of pump radiation from the pump chamber. The outer wall is coated with a high reflectance coating 24 in the form of a dielectric thin film stack, able to reflect from 0 to greater than 40° angle of incidence with a high reflectance value, or a thin metallic coating, typically of gold or protected silver. Alternatively the coating might provide diffuse rather than specular reflection, for example a ceramic such as Alumina, or other appropriate materials well known to the skilled reader. This single reflecting layer has the advantage of simplicity of design, cost and potentially for the positioning of components such as the diode pumps.

It will be appreciated that the diode pump radiation can be coupled to the pump radiation reflective chamber by any other appropriate means such as a reflective duct or concentrator.

In an alternative embodiment the coating 24 is a composite dielectric coating and thin film metallic mirror. This incorporates the ability to reflect the bulk of the radiation back in to the chamber at incident angles on the reflector of less than 40 degrees by means of the dielectric coating. The metallic coating reflects residual rays of higher angle back in to the chamber constituting a small fraction of the overall energy with a resulting reduced risk of degradation to the metallic coating in comparison to the case without application of a dielectric coating. The coatings can be applied using standard coating techniques and may be provided, alternatively, on separate surfaces to avoid heating of the dielectric layer by the metallic layer.

In the embodiment shown, the rod ends 7 include un-doped or partially doped end pieces or caps that are polished. In the preferred embodiment, the rod ends include un-doped or partially or differently doped end caps which reduce damage at the ends as there is no heating, and further reduces losses in side pumped configurations that incorporate laser media where the lower lasing level is thermally partially populated, such as Yb doped materials. In addition it is easier to apply optical coatings to the end surfaces because of the reduction in thermal stresses, and the surface can deviate less from flatness. The end caps can be attached, bonded—e.g. diffusion bonded, grown or fused to the active laser medium. These may be generally dog-boned in shape. The dog-boned shaped ends allow for chamfering the ends of the rods without decreasing the optical aperture, and reduce the risk of exposure to radiation of sealing materials such as an O-ring, resulting in improved robustness.

In a further preferred embodiment, whilst the rod has a predominantly roughened or otherwise diffusely scattering surface, at its ends it has a polished or otherwise specularly reflecting region, which reflects pumping radiation by total internal reflection back into the rod. The polished region can graduate to the roughened region or there can be a step function at the boundary. The smooth and rough regions can be achieved in any appropriate fashion as will be well known to the skilled person.

For the present embodiment in a configuration efficient for transfer of pump to lasing radiation, a typical number of passes prior to absorption is on the order of ten. Yb ions are pumped by radiation at ˜941 nm from the ground to an excited state, relaxing back to a metastable upper laser level. Stimulated emission occurs between this metastable level and a lower level above the ground state, producing laser light of 1029.3 nm. The ions then relax back to the ground state through non-radiative means. In Yb based materials, such as Yb:YAG, the upper pumping level and lower lasing level are partially thermally populated at room temperature. However, efficient laser action can be achieved at high enough pumping intensities.

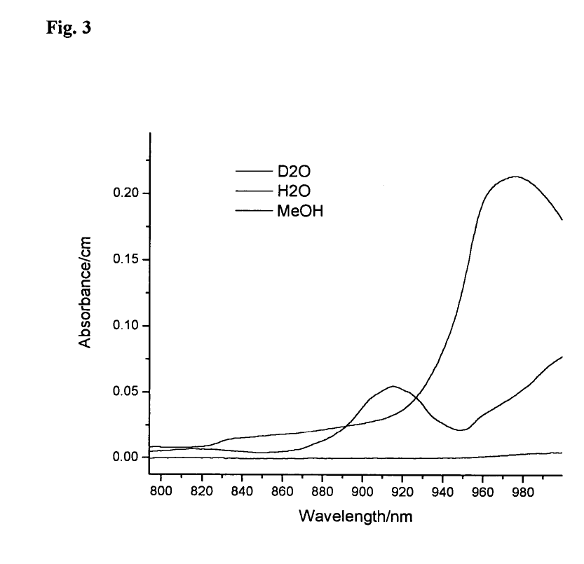

During the pumping process, D₂O is pumped around the laser gain medium to remove heat from the gain medium. Since D₂O has a low optical absorption coefficient (see FIG. 3) for the wavelength of the pumping radiation, it absorbs a relatively low proportion of the pumping radiation, so it does not heat the gain medium itself.

Three exemplary gain media are now discussed. In Yb:YAG, because of the low absorption cross section at 940 nm of 0.8×10⁻²⁰ cm², many passes are required at a typical doping level for efficient operation. Water absorption is moderate at 0.08/cm, but the multiple passes results in about 50% lost to water.

In Potassium Gadolinium Tungstate (Yb:KGW) medium absorption at 981 nm of about 2.5×10⁻²⁰ cm² but absorption in water is strong here at 0.21/cm. Although less passes are required (2 to 5 may be expected), there is still significant loss to direct water absorption.

In other media where an incomplete overlap of the pumping band of wavelengths and the desired band of absorption in the lasing medium, such that although the peak absorption cross section in the lasing medium may be high and the doping concentration of active ions may also be high, the overall absorption length for the pumping radiation in question may still be long. In this case, multiple passes may be required to absorb the pumping radiation, and the use of standard water or other standard coolants could result in a significant decrease in efficiency for the device. An example where standard pumping solutions are broader than the preferred absorption band for the lasing medium is for Yb:KGW which has a bandwidth of 3.7 nm in comparison to cost effective, standard diode units which have a bandwidth of 6 nm. A scheme employing more passes through the gain medium has the advantage that is it more robust to changes in bandwidth or center wavelength of the pumping source.

Any appropriate material may be selected for the gain medium such as Yb:KYW, Yb:GdCOB, Yb:GGG, or sesquioxides such as Yb:Sc₂O₃, Yb:Y₂O₃, Yb:LU₂O₃.

The gain medium is preferably rod shaped with the cross section approximating to circular or elliptical, but the cross section can include square, rectangular or other polygons and/or varying cross-sections. Indeed the rod may be tapered to encourage the ejection of radiation from the medium where the bulk of the medium has a fine ground or polished side surface that partially supports parasitic lasing action in the form of barrelling rays undergoing total internal reflection to experience long gain path lengths.

In each of these the use of D₂O as a coolant is highly advantageous. Compared to other coolants, water has the highest specific heat and thermal conductivity and the lowest viscosity. As such, water can remove the largest heat load from the gain medium. D₂O has very similar physical properties to standard water, but with the advantage of a low absorption of optical radiation at wavelengths of interest.

It will be understood by those skilled in that field that the present invention is not limited to the embodiment described above. In particular, D₂O can be used as a coolant for a variety of gain media in a range of pumping configurations, while still providing the advantages of the present invention. Also, D₂O may find the advantages of this invention outside the spectral region emphasized by this application. This invention is not limited to pumping of laser media solely between 800 and 1000 nm.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A laser apparatus, comprising:
a pump radiation source for emitting pumping radiation into a pumping radiation reflective cavity;
a gain medium located in the pumping radiation reflective cavity and arranged to absorb the pumping radiation and thereby emit a laser light; and
a cooling arrangement located in the cavity to cool the gain medium; wherein the cooling arrangement comprises a coolant which in turn comprises heavy water (D₂O).

2. A laser apparatus as defined in claim 1, wherein the coolant is disposed between the pump radiation source and the gain medium.

3. A laser apparatus as defined in claim 1, wherein the gain medium has first and second ends on a laser extraction axis, and wherein the pump radiation source is arranged so that the pumping radiation is directed to a side of the gain medium.

4. An A laser apparatus as defined in claim 3, wherein the gain medium comprises a diffusely scattering surface.

5. An A laser apparatus as defined in claim 1, wherein the gain medium has an absorption length such that, on average, the pumping radiation performs multiple passes through the gain medium prior to absorption thereby.

6. A laser apparatus as defined in claim 5, wherein the pumping radiation performs more than five passes through the gain medium prior to absorption thereby.

7. A laser apparatus as defined in claim 1, wherein the gain medium is Yb based.

8. A laser apparatus as defined in claim 1, wherein the pump radiation source comprises:
one or more laser diode sources and/or one or more flash lamp sources.

9. An A laser apparatus as defined in claim 1, wherein the cooling arrangement comprises:
a convection cooling system and/or a conduction cooling system.

10. A laser apparatus as defined in claim 1, wherein the cooling arrangement is applied to restricted regions which are located on a side of the gain medium.

11. A laser apparatus as defined in claim 1, wherein the gain medium is surrounded by a first reflector layer comprising a dielectric reflecting layer and a second reflector layer comprising a metallic reflecting layer.

12. A laser apparatus as defined in claim 1, wherein the gain medium has first and second ends on a laser extraction axis, and wherein said gain medium also has a diffusely scattering surface having specularly reflecting regions which are located at each of the first and second ends of the gain medium.

13. A laser apparatus, comprising:
a pump radiation source for emitting pumping radiation; and
a gain medium arranged to absorb the pumping radiation and thereby emit laser light, wherein the gain medium is surrounded by a first reflector layer comprising a dielectric reflecting layer and a second reflector layer comprising a metallic reflecting layer.

14. A laser apparatus, comprising:
a pump radiation source for emitting pumping radiation; and
a gain medium arranged to absorb the pumping radiation and thereby emit laser light, wherein the gain medium has first and second ends on a laser extraction axis, and wherein the gain medium also has a diffusely scattering surface which is located between the first and second ends of the gain medium; and wherein the diffusely reflecting surface has specularly reflecting side regions located at each of the first and second ends of the gain medium.

15. A laser apparatus, comprising:
a pump radiation source for emitting pumping radiation source in the range between approximately 800 nm and approximately 1300 nm;
a gain medium arranged to absorb the pumping radiation and thereby emit a laser light; and
a cooling arrangement for cooling the gain medium, the cooling arrangement comprising a coolant which in turn comprises heavy water (D₂O).

16. (Cancelled)

17. A laser apparatus, comprising:
a pump radiation source for emitting pumping radiation into a pumping radiation reflective cavity;
a gain medium located in the pumping radiation reflective cavity and arranged to absorb the pumping radiation and thereby emit a laser light, wherein the gain medium has an absorption length such that the ipumping radiation performs multiple passes through the gain medium prior to absorption by the gain medium; and
a cooling arrangement located in the cavity for cooling the gain medium, the cooling arrangement comprising a coolant disposed between the pump radiation source and the gain medium, wherein the coolant comprises heavy water (D₂O.

18. A laser apparatus as defined in claim 17, wherein the gain medium has first and second ends on a laser extraction axis, and wherein the pump radiation source is arranged so that the pumping radiation is directed to a side of the gain medium, and wherein the gain medium comprises a diffusely scattering surface.

19. A laser apparatus as defined in claim 17, wherein the cooling arrangement is applied to restricted regions which are located on a side of the gain medium.

20. A laser apparatus as defined in claim 17, wherein the gain medium is surrounded by a first reflector layer comprising a dielectric reflecting layer and a second reflector layer comprising a metallic reflecting layer.

21. A laser apparatus as defined in claim 17, wherein the gain medium has first and second ends on a laser extraction axis, and wherein said gain medium also has a diffusely scattering surface having specularly reflecting regions which are located at each of the first and second ends of the gain medium.
